(19) United States
(12) Patent Application Publication
(10) Pub. No.: US 2025/0199665 A1
(43) Pub. Date: Jun. 19, 2025

(54) VIDEO MANAGEMENT METHOD AND APPARATUS, ELECTRONIC DEVICE, AND READABLE STORAGE MEDIUM

(71) Applicant: VIVO MOBILE COMMUNICATION CO., LTD., Dongguan (CN)

(72) Inventor: Chao BIAN, Dongguan (CN)

(73) Assignee: VIVO MOBILE COMMUNICATION CO., LTD., Dongguan (CN)

(21) Appl. No.: 19/067,772

(22) Filed: Feb. 28, 2025

Related U.S. Application Data
(63) Continuation of application No. PCT/CN2023/115252, filed on Aug. 28, 2023.

(30) Foreign Application Priority Data
Sep. 2, 2022 (CN) 202211077226.2

(51) Int. Cl. G06F 3/0484; G06F 3/0483; G06F 9/451

(52) U.S. Cl. CPC G06F 3/0484; G06F 3/0483; G06F 9/451

(57) ABSTRACT

This application provides a video management method and apparatus, an electronic device, and a readable storage medium. The video management method includes: receiving a first input from a user; and performing a target operation in response to the first input. The target operation includes any one of the following: establishing an association relationship between a first video in a first application and a target component, or playing a second video in a second application by using the target component. The association relationship is used to indicate that the first video is playable by using the target component. The second video is a video in the second application with a playing progress meeting a first preset condition.

### CROSS-REFERENCE TO RELATED APPLICATIONS

This application is a continuation of International Application No. PCT/CN 2023/115252, filed on Aug. 28, 2023, which claims priority to Chinese Patent Application No. 202211077226.2, filed on Sep. 2, 2022. The entire contents of each of the above-referenced applications are expressly incorporated herein by reference.

### TECHNICAL FIELD

This application pertains to the field of communication technologies, and in particular, to a video management method and apparatus, an electronic device, and a readable storage medium.

### BACKGROUND

With the development of communication technologies, functions of electronic devices are becoming more and more powerful, and a video playing function of the electronic device is also increasingly optimized. A plurality of applications with the video playing function can be set in the electronic device, and each application can play a video unique to the application or a video shared by at least two applications. Due to the accelerating pace of life, many users like to use spare time to view multimedia files, such as a TV series, a movie, and a live video. After viewing a video by using an application, if the user needs to view the video again because of incomplete viewing or other reasons, the user needs to look through historical viewing records of a plurality of applications on the electronic device to find the video, which leads to a cumbersome and time-consuming operation for finding the historically viewed multimedia file on the electronic device.

### SUMMARY

Embodiments of this application aim to provide a video management method and apparatus, an electronic device, and a readable storage medium.

According to a first aspect, an embodiment of this application provides a video

management method, and the method includes:

receiving a first input from a user; and

performing a target operation in response to the first input, where

the target operation includes any one of the following:

establishing an association relationship between a first video in a first application and a target component, where the association relationship is used to indicate that the first video is able to be played by using the target component; and

playing a second video in a second application by using the target component, where the second video is a video in the second application with a playing progress meeting a first preset condition.

According to a second aspect, an embodiment of this application provides a video management apparatus, and the apparatus includes:

a first receiving module, configured to receive a first input from a user; and

an execution module, configured to perform a target operation in response to the first input, where

the target operation includes any one of the following:

establishing an association relationship between a first video in a first application and a target component, where the association relationship is used to indicate that the first video is able to be played by using the target component; and

playing a second video in a second application by using the target component, where the second video is a video in the second application with a playing progress meeting a first preset condition.

According to a third aspect, an embodiment of this application provides an electronic device. The electronic device includes a processor and a memory, the memory stores a program or an instruction that can be run on the processor, and the program or the instruction is executed by the processor to implement the steps of the method according to the first aspect.

According to a fourth aspect, an embodiment of this application provides a readable storage medium. The readable storage medium stores a program or an instruction, and the program or the instruction is executed by a processor to implement the steps of the method according to the first aspect.

According to a fifth aspect, an embodiment of this application provides a chip. The chip includes a processor and a communication interface, the communication interface is coupled to the processor, and the processor is configured to run a program or an instruction to implement the method according to the first aspect.

According to a sixth aspect, an embodiment of this application provides a computer program product. The program product is stored in a storage medium, and the program product is executed by at least one processor to implement the method according to the first aspect.

In the embodiments of this application, the electronic device can take the first input as a trigger operation to establish the association relationship between the first video and the target component, and quickly and easily establish the association relationship between the first video that is in-completed in playing in the first application and that the user needs to continue to play later and the target component, so that when the user needs to view the first video later, the first video may be directly found and played by using the target component, and the user does not need to look through a plurality of applications to find and play the first video. Operation steps are simple and consume less time. In addition, the electronic device can further take the first input as a trigger operation for using the target component to play the second video in the second application with the playing progress meeting the first preset condition, which is convenient for the user to play the second video quickly by using the target component, and prevents the user from finding and playing the second video in the second application, thus saving time.

### BRIEF DESCRIPTION OF DRAWINGS

FIG. 1 is a schematic flowchart of a video management method according to an embodiment of this application;

FIG. 2 is a first schematic diagram of establishing an association relationship between a first video and a target component according to an embodiment of this application;

FIG. 3 is a second schematic diagram of establishing an association relationship between a first video and a target component according to an embodiment of this application;

FIG. 4 is a first schematic diagram of switching a second video to a third video according to an embodiment of this application;

FIG. 5 is a second schematic diagram of switching a second video to a third video according to an embodiment of this application;

FIG. 6 is a schematic diagram of canceling an association relationship between a first target video and a target component according to an embodiment of this application;

FIG. 7 is a third schematic diagram of switching a second video in a target component to a third video according to an embodiment of this application;

FIG. 8 is a schematic diagram of a structure of a video management apparatus according to an embodiment of this application;

FIG. 9 is a schematic diagram of a structure of an electronic device according to an embodiment of this application; and

FIG. 10 is a schematic diagram of a hardware structure of an electronic device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects.

The following describes in detail the video management method provided in the embodiments of this application through specific embodiments and application scenarios thereof with reference to the accompanying drawings.

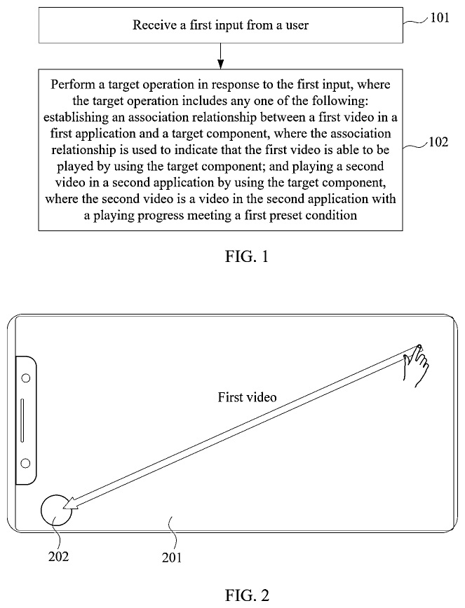

FIG. 1 is a schematic flowchart of a video management method according to an embodiment of this application. The video management method provided in the embodiments of this application may be performed by, for example, an electronic device, and the electronic device includes but is not limited to devices with multimedia playing and information display functions such as a smart phone, a tablet computer, a desktop computer, a notebook computer, a palmtop computer, a vehicle-mounted terminal, a wearable device, and the like.

As shown in FIG. 1, the video management method in this embodiment may include the following step 101 and step 102.

Step 101: Receive a first input from a user.

Step 102: Perform a target operation in response to the first input.

The target operation includes any one of the following.

Establishing an association relationship between a first video in a first application and a target component, where the association relationship is used to indicate that the first video is able to be played by using the target component.

In this embodiment, the target component is a component that can be used to display and play the first video in the first application, the first application may be any application with a video playing function in the electronic device, and the first video may be any video in the first application.

In this embodiment, the first input is used to establish the association relationship between the first video in the first application and the target component. The association relationship is used to indicate that the first video can be viewed and played by using the target component. The first input may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture.

In this embodiment, the first input may be a dragging operation in which the user drags the first video in the first application into a component icon corresponding to the target component; and the first input may also be a dragging operation in which the user drags an application icon corresponding to the first application into the target component.

In this embodiment of this application, in a case that the first input is the dragging operation in which the user drags the first video in the first application into the component icon corresponding to the target component, the association relationship between the first video in the first application and the target component is established in response to the first input.

For example, as shown in FIG. 2, the electronic device plays a first video 201 of the first application, and a component icon 202 corresponding to the target component is displayed on a video playing interface of the first video 201. In a case that the user drags the first video 201 of the first application into the component icon 202 corresponding to the target component, the association relationship between the first video 201 in the first application and the target component is established.

For example, when the user views a fifth episode of TV series A by using the first application, if the user needs to stop viewing TV series A and expects to continue to view TV series A later, the first input may be performed on a current video frame of the fifth episode of TV series A, to drag the current video frame into a component icon corresponding to the target component, and establish an association relationship between TV series A and the target component. In this way, when the user expects to continue to view TV series A later, the user may directly find and play TV series A by using the target component, and when the target component is used to play TV series A, TV series A can be played from a historical playing progress of TV series A, that is, the current video frame of the fifth episode of TV series A is used as an initial video frame to continue to play TV series A. TV series A is the first video, and the current video frame is a currently playing video frame in the fifth episode of TV series A.

In this embodiment, the component icon 202 corresponding to the target component may be a floating icon. When the user plays the first video 201 by using the first application, the component icon 202 may synchronously float on the video playing interface of the first video 201, which is convenient for the user to quickly establish the association relationship between the first video 201 and the target component by using the component icon 202 of the target component.

In this embodiment, when the user plays the first video 201 by using the first application, the component icon 202 may synchronously float on the video playing interface of the first video 201; and when the user closes the video playing interface of the first video 201, the component icon 202 is not displayed. The component icon 202 may float at any position on the video playing interface of the first video 201. For example, the component icon 202 may be located in a lower left corner of the video playing interface of the first video 201.

In this embodiment of this application, in a case that the first input is the dragging operation in which the user drags the application icon corresponding to the first application into the target component, and there is no association relationship between the first video in the first application and the target component, the association relationship between the first video in the first application and the target component is established in response to the first input.

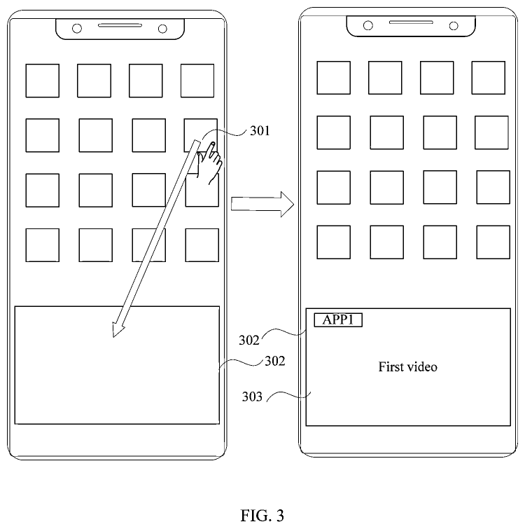

For example, as shown in FIG. 3, in a case that the user drags an application icon of a first application 301 into a target component 302, and there is no association relationship between a first video 303 in the first application 301 and the target component 302, an association relationship between the first video 303 in the first application 301 and the target component 302 is established. In addition, the target component 302 displays the first video 303 in the first application 301.

In this embodiment of the present disclosure, the electronic device can take the first input performed on the first video in the first application as a trigger operation to establish the association relationship between the first video and the target component, and quickly and easily establish the association relationship between the first video that is in-completed in playing in the first application and that the user needs to continue to play later and the target component, so that when the user needs to view the first video later, the first video may be directly found and played by using the target component, and the user does not need to look through a plurality of applications to find and play the first video. Operation steps are simple and consume less time.

Playing a second video in a second application by using the target component, where the second video is a video in the second application with a playing progress meeting a first preset condition.

In this embodiment, the target component may be disposed on a home screen of the electronic device, a position of the target component may be set by the user, and the position of the target component may be adjusted based on preference of the user.

In this embodiment, the first input is used to control the target component to play the second video in the second application with the playing progress meeting the first preset condition. The first input may be a dragging operation in which the user drags an application icon corresponding to the second application into the target component.

In this embodiment of this application, in a case that the first input is the dragging operation in which the user drags the application icon corresponding to the second application into the target component, the second video in the second application with the playing progress meeting the first preset condition is determined, and the second video is directly played by using the target component, so that the user does not need to find and play the second video in the second application, and the operation steps are simple.

In this embodiment of the present disclosure, the electronic device can take the first input performed on the target component and the second application as a trigger operation for using the target component to play the second video in the second application with the playing progress meeting the first preset condition, which is convenient for the user to play the second video quickly by using the target component, and prevents the user from finding and playing the second video in the second application, thus saving time.

In an embodiment, that the second video is a video in the second application with a playing progress meeting a first preset condition includes: the second video is a video in the second application with a playing progress less than a first playing progress; or the second video is a video in the second application with a playing progress less than a second playing progress in a preset time period.

In this embodiment, the second video may be a video with a playing progress less than the first playing progress in all historical playing records of the second application, and the first playing progress may be set by the user, which is not specifically limited in this embodiment.

In this embodiment, the second video may also be a video with a playing progress less than the second playing progress in a preset time period of the second application, and both the preset time period and the second playing progress may be set by the user, which is not specifically limited in this embodiment. For example, the preset time period may be 5 days. In this embodiment, the first playing progress may be the same as or different from the

second playing progress.

For example, both the first playing progress and the second playing progress may be 50%.

For another example, the first playing progress may be 50%, and the second playing progress may be 60%.

In this embodiment of the present disclosure, when the second video in the second application is played by using the target component, the second video may be a video with a playing progress less than the first playing progress in all the historical playing records of the second application, or a video with a playing progress less than the second playing progress in the preset time period of the second application. A corresponding first preset condition is selected based on a user requirement, so that the second video in the second application can be determined more accurately, and the second video can be played quickly by using the target component, to meet the user requirement.

In an embodiment, after the target operation is performed in response to the first input, the video management method further includes: receiving a second input for the target component from the user; and playing a third video by using the target component in response to the second input, where the third video is a video in a third application.

In this embodiment, it should be noted that videos that are in the association relationship with the target component may be divided into a TV series, a movie, a variety show, a live video, a short video, and other videos based on a video type, and may also be divided into a horizontal-orientation video and a vertical-orientation video based on a video layout. In a case that a width of a video is greater than a height, the video is a horizontal-orientation video; and in a case that a width of a video is less than a height, the video is a vertical-orientation video.

In this embodiment, the third application and the second application may be the same application or different applications.

In this embodiment, the second input is used to switch the second video being played in the target component to the third video. A layout of the third video may be the same or different from a layout of the second video. The second input may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture. For example, the specific gesture may be a sliding input at any position of a video window. In actual application, a direction of the sliding input may be preset, and the user may operate based on the preset direction. The direction of the sliding input may also be set by the user based on an operating habit, which is not specifically limited in this embodiment.

In this embodiment, the second input may be a left sliding operation or a right sliding operation of the user on any position of the target component; and the second input may also be an upward sliding operation or a downward sliding operation of the user on any position of the target component, and may also be an oblique sliding operation performed by the user to slide, in the target component, from a lower left corner of the target component to an upper right corner of the target component.

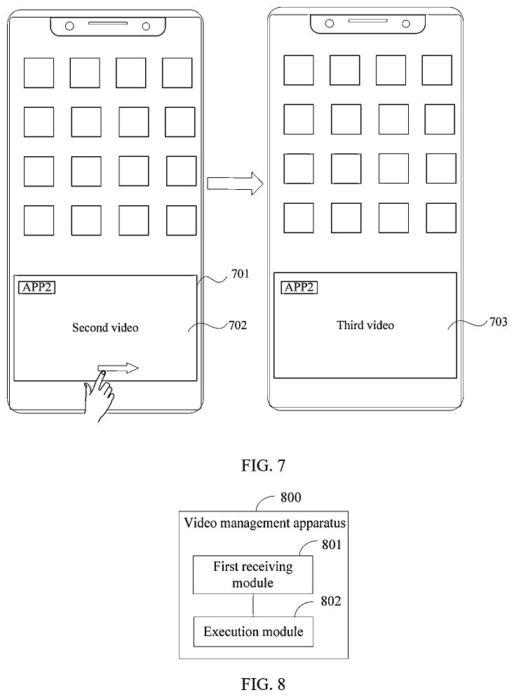

As shown in FIG. 7, in this embodiment of this application, in a case that the third application and the second application are the same application, and the second input is a left sliding operation or a right sliding operation of the user on any position of the target component, a second video 802 currently played by using a target component 801 is switched to a third video 803, where a layout of the third video 803 is the same as that of the second video 802, which is convenient for the user to view and play, in the target component, different videos of the same layout in the same application. Operation steps are simple, and time can be saved.

For example, both movie A and movie B are horizontal-orientation videos in the second application. In a case that a video currently played by using the target component is movie A, and the user performs the left sliding operation on any position of the target component, the target component switches movie A to movie B, and plays movie B.

In this embodiment of the present disclosure, the electronic device can take the second input performed on the target component as a switching trigger operation to switch the second video currently played by using the target component to the third video, and quickly and easily switch the second video currently played by using the target component to the third video, where the third video and the second video are different videos of the same layout in the same application, so that different videos of the same layout in the same application are switched in the target component, and it is convenient for the user to quickly view and play, in the target component, different videos of the same layout in the same application. Operation steps are simple, and time can be saved.

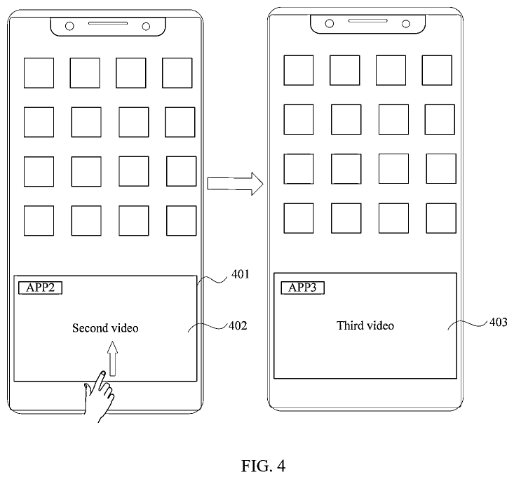

As shown in FIG. 4, in this embodiment of this application, in a case that the third application and the second application are different applications, and the second input is an upward sliding operation or a downward sliding operation of the user on any position of a target component 401, a second video 402 currently played by using the target component 401 is switched to a third video 403, where a layout of the third video 403 is the same as that of the second video 402, which is convenient for the user to view and play, in the target component 401, videos of the same layout in different applications. Operation steps are simple, and time can be saved.

For example, the second video is movie B in the second application, the third video is TV series C in the third application, and both movie A and TV series C are horizontal-orientation videos. In a case that a video currently played by using the target component is movie B, and the user performs the upward sliding operation on any position of the target component, the target component switches movie B to TV series C, and plays TV series C.

For another example, the second video is short video E in the second application, the third video is short video F in the third application, and both short video E and short video F are vertical-orientation videos. In a case that a video currently played by using the target component is short video E, and the user performs the downward sliding operation on any position of the target component, the target component switches short video E to short video F, and plays short video F.

In this embodiment of the present disclosure, the electronic device can take the second input performed on the target component as a switching trigger operation to switch the second video currently played by using the target component to the third video, and quickly and easily switch the second video played by using the target component to the third video, where the third video and the second video are videos of the same layout in different applications, so that videos of the same layout in different applications are switched in the target component, and it is convenient for the user to quickly view and play, in the target component, the videos of the same layout in the different applications. Operation steps are simple, and time can be saved.

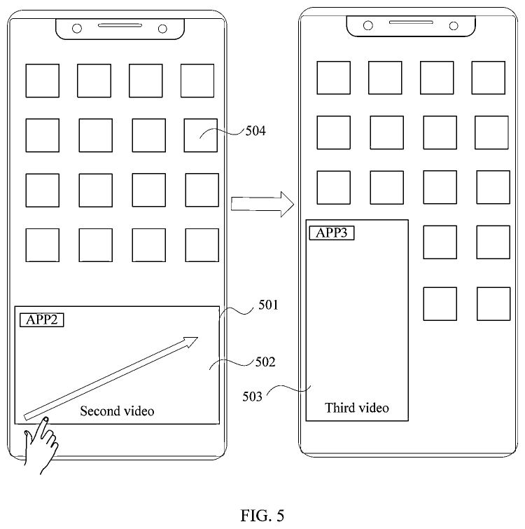

As shown in FIG. 5, in this embodiment of this application, in a case that the third application and the second application are different applications, and the second input is an oblique sliding operation performed by the user to slide, in a target component 501, from a lower left corner of the target component 501 to an upper right corner of the target component 501, a second video 502 currently played by using the target component 501 is switched to a third video 503, where a layout of the third video 503 is different from that of the second video 502, which is convenient for the user to view and play, in the target component 501, videos of different layouts in different applications. Operation steps are simple, and time can be saved.

For example, the second video is movie B in the second application, the third video is short video F in the third application, movie B is a horizontal-orientation video, and short video F is a vertical-orientation video. In a case that a video currently played by using the target component is movie B, and the user performs oblique sliding, in the target component, from the lower left corner of the target component to the upper right corner of the target component, the target component switches movie B to short video F, and plays short video F.

As shown in FIG. 5, in this embodiment, a shape of the target component 501 is adapted

to a layout of a video currently played by using the target component 501, and the target component 501 is in different shapes when the second video 502 and the third video 503 with different layouts are played. The shape of the target component 501 includes a first shape and a second shape. The shape of the target component 501 is the first shape when the second video 502 is played, the shape of the target component 501 is the second shape when the third video 503 is played, and the target component 501 can adjust the shape thereof based on the layouts of the second video 502 and the third video 503, so that the target component 501 can better display and play videos with different layouts, to ensure playing effect of the target component 501.

As shown in FIG. 5, in this embodiment, in a case that the second video 502 is a horizontal-orientation video, the shape of the target component 501 is the first shape, and in this case, a width of the target component 501 is greater than a height of the target component 501; and in a case that the third video 503 is a vertical-orientation video, the shape of the target component 501 is the second shape, and in this case, the width of the target component 501 is less than the height of the target component 501.

For example, the target component plays, in the first shape, movie B in the second application, and in a case of receiving an oblique sliding operation performed by the user to slide, in the target component, from a lower left corner of the target component to an upper right corner of the target component, the target component switches the currently played movie B to short video F. In addition, the target component is switched from the first shape to the second shape, and plays short video F in the second shape.

As shown in FIG. 5, in this embodiment, when the target component 501 plays the second video 502 in the first shape, the target component 501 and icons 504 of applications on the home screen of the electronic device are arranged in a first arrangement mode; and when the target component 501 plays the third video 503 in the second shape, the target component 501 and the icons 504 of the applications on the home screen of the electronic device are arranged in a second arrangement mode, to adjust the arrangement mode of the icons 504 of the applications on the home screen of the electronic device in a case that the target component 501 is switched from the first shape to the second shape, and enable a display interface of the electronic device to be clean and aesthetic.

For example, as shown in FIG. 5, in a case that the target component 501 plays the second video 502, the icons 504 of the applications on the home screen of the electronic device are arranged in four rows and four columns, and the target component 501 is located below the icons 504 of the applications on the home screen; and in a case that the target component 501 plays the third video 503, the target component 501 is located in the lower left corner of a display screen of the electronic device, and in this case, the icons 504 of the applications on the home screen are automatically adjusted based on a position of the target component 501.

In this embodiment of the present disclosure, the electronic device can take the second input performed on the target component as a switching trigger operation to switch a video played by using the target component from the second video to the third video, and quickly and easily switch the second video played by using the target component to the third video, where the third video and the second video are videos of different layouts in different applications, so that videos of different layouts in different applications are switched in the target component, and it is convenient for the user to quickly view and play, in the target component, videos of different layouts in different applications. Operation steps are simple, and time can be saved.

In an embodiment, the receiving a first input from a user, and performing a target operation in response to the first input includes: receiving the first input from the user in a case that a video playing interface of the first application is displayed; and performing the target operation in response to the first input.

In this embodiment, in a case that the video playing interface of the first application is displayed, the association relationship between the first video in the first application and the target component is established in response to the first input, where the first input may be a dragging operation in which the user drags the first video in the first application into a component icon corresponding to the target component.

After the target operation is performed, the video management method further includes: displaying the target component and a first application identifier in a case that the target operation is to establish the association relationship between the first video in the first application and the target component, where the first application identifier is used to indicate the first application; receiving a third input for the target component and the first application identifier from the user; and playing the first video by using the target component in response to the third input.

In this embodiment, the first application identifier is an application icon of the first application on the electronic device.

In this embodiment, the third input is used to control the target component to play the first video in the first application. The third input may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture.

In this embodiment, the third input may be a dragging operation in which the user drags the first application identifier into the target component.

In this embodiment of this application, in a case that the third input is the dragging operation in which the user drags the first application identifier into the target component, and there is an association relationship between the first video and the target component, the first video is played by using the target component, which is convenient to quickly locate, in the target component, the first video in the first application.

In this embodiment of the present disclosure, the electronic device can take the third input performed on the target component and the first application identifier as a playing trigger operation for using the target component to play the first video in the first application, which is convenient for the user to quickly locate, in the target component, the first video in the first application, and prevents the user from finding, in the target component, the first video corresponding to the first application. This is easy to operate and can save time.

In an embodiment, after the target operation is performed in response to the first input, the video management method further includes: canceling performing the target operation in a case that a second preset condition is met.

The second preset condition includes any one of the following: a playing progress of playing a first target video by using the target component is greater than a third playing progress; and a deletion operation performed by the user on the first target video is received, where the first target video is the first video or the second video.

In this embodiment, in a case that the playing progress of playing the first target video by using the target component is greater than the third playing progress, or the deletion operation performed by the user on the first target video is received, the association relationship between the first target video and the target component is canceled.

In this embodiment, the third playing progress may be used to indicate that the first target video is completed in playing. In a case that the playing progress of playing the first target video by using the target component is greater than the third playing progress, the association relationship between the target component and the first target video is automatically canceled. In actual application, the third playing progress may be set by the user according to an actual use requirement of the user, and is not specifically limited in this embodiment.

For example, the third playing progress may be set to 98%, and the playing progress of the first target video is 30% in a case that the association relationship between the first target video and the target component is established. In a process of playing the first target video by using the target component, if the playing progress of the first target video is greater than 98%, it can be considered that the first target video is completed in playing, and the association relationship between the target component and the first target video is automatically canceled.

In this embodiment of the present disclosure, in a case that the playing progress of playing the first target video by using the target component is greater than the third playing progress, it indicates that the first target video is completed in playing, and the electronic device may automatically cancel the association relationship between the first target video and the target component, so that the user does not need to manually cancel the association relationship between the first target video and the target component after the first target video is completed in playing, and the first target video that is completed in playing may not affect the user to find other videos in the target component, which can save time.

In this embodiment, in a case that the deletion operation performed by the user on the first target video is received, the association relationship between the first target video and the target component is canceled in response to the deletion operation, so that the user can manually cancel the association relationship between the first target video and the target component in a case that the playing progress of the first target video is less than the third playing progress, and the user does not expect to continue to view the first target video later, which is convenient for the user to manage the first target video in the target component.

In this embodiment, the deletion operation is used to cancel the association relationship between the first target video and the target component, and the deletion operation may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture.

In this embodiment, the deletion operation may be, for example, an operation of dragging the first target video in the target component away from the target component.

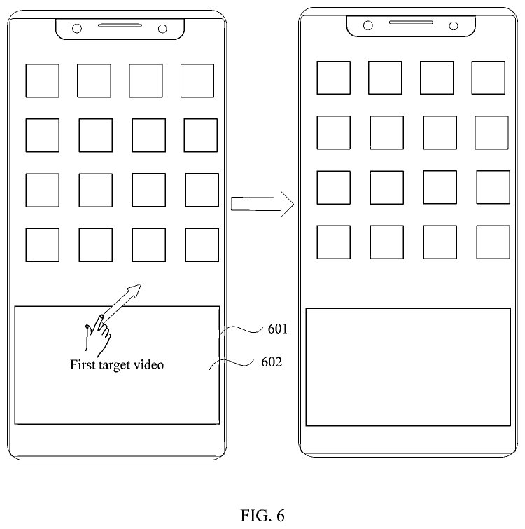

For example, as shown in FIG. 6, a target component 601 displays a first target video 602, and in a case that the user drags the first target video 602 in the target component 601 away from the target component 601, an association relationship between the first target video 602 and the target component 601 is canceled.

In this embodiment of the present disclosure, the electronic device can take the deletion operation performed on the first target video in the target component as a trigger operation to cancel the association relationship between the first target video and the target component, and can manually cancel the association relationship between the first target video and the target component in a case that the playing progress of the first target video is less than the third playing progress, and the user does not expect to continue to view the first target video later, which is convenient for the user to manage the first target video in the target component. Operation steps are simple, and time can be saved.

In an embodiment, after the target operation is performed in response to the first input, the video management method further includes: receiving a fourth input for the target component and a target application in a case that a second target video is played by using the target component; and

in a case that the second target video is a video in the target application, in response to the fourth input, playing the second target video when the target application is started.

The second target video is the first video, and the target application is the first application; or the second target video is the second video, and the target application is the second application.

In this embodiment, in a case that the second target video is the first video, the target application is the first application; and in a case that the second target video is the second video, the target application is the second application, that is, the target application has a playing copyright of the second target video.

In this embodiment, the fourth input is used to determine the second target video as a to-be-played video of the target application, and automatically play the predetermined to-be-played video by using the target application when the target application is started. The fourth input may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture.

In this embodiment, the fourth input may be an operation in which the user drags the second target video in the target component onto an application icon corresponding to the target application.

As shown in FIG. 7, in this embodiment of this application, in a case that the fourth input is the operation in which the user drags the second target video in the target component onto the application icon corresponding to the target application, the second target video is determined as the to-be-played video of the target application, so that when the user opens the target application, the to-be-played video may be automatically played by using the target application, that is, the second target video is automatically played by using the target application. When the second target video is automatically played by using the target application, the second target video may be continued to be played from a historical playing progress of the second target video.

For example, in a case that an association relationship between TV series A in the first application and the target component has been established, and the user expects to continue to play TV series A when the first application is started next time, TV series A may be determined as the to-be-played video of the first application by dragging TV series A in the target component to the application icon corresponding to the first application. When the user opens the first application next time, the first application may automatically play TV series A from a historical playing progress of TV series A, which is convenient for the user to follow the TV series.

In this embodiment of the present disclosure, in a case that the target application has the playing copyright of the second target video, the fourth input may be used to determine the second target video as the to-be-played video of the target application, and the predetermined to-be-played video may be automatically played by using the target application when the target application is started, which prevents the user from still finding and playing the second target video in the target application or the target component. Operation steps are simple and quick, and time can be saved.

In a case that the second target video is a video in a fourth application, in response to the fourth input, a fourth video is played when the target application is started, where the fourth video is associated with the second target video.

In this embodiment, the second target video is a video in the fourth application, that is, the fourth application has a playing copyright of the second target video; and the target application is the first application or the second application, and the target application does not have the playing right of the second target video.

In this embodiment, it should be noted that the association between the fourth video and the second target video may be that a type of the fourth video is the same as that of the second target video, a publisher of the fourth video is the same as that of the second target video, or the like. This is not specifically limited in this embodiment.

For example, in a case that the second target video is a competition video of an Olympic table tennis event, the fourth video is associated with the second target video, and the fourth video may be a collection of highlights of the Olympic table tennis event. The type of the fourth video is the same as that of the second target video.

For another example, in a case that the second target video is a Xi'an Tourism vlog released by blogger C, the fourth video is associated with the second target video, and the fourth video may be a Beijing Tourism vlog released by blogger C before. The publisher of the fourth video is the same as that of the second target video.

In this embodiment, the fourth input is used to determine the fourth video associated with the second target video in the target application, and when the target application is started, the fourth video is automatically played by using the target application. The fourth input may be a voice command entered by the user, or a specific gesture entered by the user, which can be determined according to actual use requirements in actual application and is not specifically limited in this embodiment. In this embodiment, the specific gesture may be any one of: a single-tap gesture, a sliding gesture, a dragging gesture, a pressure recognition gesture, a long press gesture, an area change gesture, a double-press gesture, and a double-tap gesture.

In this embodiment, the fourth input may be an operation in which the user drags the second target video in the target component onto an application icon corresponding to the target application.

In this embodiment of this application, in a case that the fourth input is that the user drags the second target video in the target component onto the application icon corresponding to the target application, the fourth video associated with the second target video exists in the target application is determined, so that when the user opens the target application, the fourth video may be automatically played by using the target application, which is convenient for recommending videos to the user according to user preferences.

For example, when the second target video is the competition video of the Olympic table tennis event, the target application may determine a fourth video associated with the Olympic table tennis event in the target application when the user drags the second target video in the target component onto the application icon corresponding to the target application. For example, the fourth video is the collection of highlights of the Olympic table tennis event, and when the user opens the target application next time, the target application may automatically play the collection of highlights of the Olympic table tennis event, to recommend videos to the user according to user preferences.

In this embodiment of the present disclosure, in a case that the target application does not have the playing copyright of the second target video, the fourth video associated with the second target video may be determined in the target application through the fourth input, and the fourth video may be automatically played by using the target application when the target application is started, to recommend videos to the user according to user preferences.

In an embodiment, after the target operation is performed, the video management method further includes: playing a third target video by using the target component, and displaying video information of the third target video on a video playing interface, where the third target video is the first video or the second video; and the video information includes at least one of video playing mode information, a video theme, a video publisher, video duration, a video playing progress, and a video source application.

In this embodiment, video playing modes may be correspondingly divided into a TV series mode, a movie mode, a live broadcast mode, a long video mode, a short video mode, and other modes based on a video type. The TV series mode includes a TV series and a variety show; the movie mode includes a movie; the live broadcast mode includes a live video; the long video mode includes a video with video duration longer than preset duration and not belonging to the TV series mode, the movie mode, and the live broadcast mode; the short video mode includes a video with video duration less than the preset duration; and other modes include videos that do not belong to the TV series mode, the movie mode, the live broadcast mode, the long video mode, and the short video mode. The preset duration can be set by the user. For example, the preset duration may be 20 minutes.

In this embodiment, different video playing modes are set for the target component, and a plurality of videos in the target component are classified based on the video playing modes, so that the user can quickly find an expected video through the video playing modes, and operation steps are simple.

In this embodiment of the present disclosure, in a case that the third target video is played by using the target component, at least one of video playing mode information, a theme, a publisher, duration, a playing progress, and a source application of the third target video is displayed on the video playing interface of the third target video, which is convenient for the user to quickly and intuitively learn of video information of the third target video, and avoids the user from viewing more video information about the third target video through other operations, thus saving time.

In an embodiment, the displaying video information of the third target video on a video playing interface includes: displaying the video information on a video page of the third target video with a second display parameter based on a first display parameter of the video page of the third target video, where the first display parameter includes at least one of a video page layout of the third target video and a video page color of the third target video; and the second display parameter includes at least one of a display location of the video information and a color attribute of the video information.

In this embodiment of the present disclosure, a display location and a display color of the video information on the video page of the third target video may be adaptively adjusted based on the video page layout and the video page color of the third target video, to avoid affecting the video page of the third target video when the video information of the third target video is displayed on the video page of the third target video, so that the video page of the third target video and the video information of the third target video can be displayed normally with good display effect.

The video management method provided in this embodiment of this application may be executed by a video management apparatus. In the embodiments of this application, an example in which the video management apparatus performs the video management method is used to describe the video management apparatus provided in the embodiments of this application.

FIG. 8 is a schematic diagram of a structure of a video management apparatus according to an embodiment of this application. As shown in FIG. 8, the video management apparatus 800 in this embodiment of this application includes a first receiving module 801 and an execution module 802.

The first receiving module 801 is configured to receive a first input from a user.

The execution module 802 is configured to perform a target operation in response to the first input.

The target operation includes any one of the following: establishing an association relationship between a first video in a first application and a target component, where the association relationship is used to indicate that the first video is able to be played by using the target component; and playing a second video in a second application by using the target component, where the second video is a video in the second application with a playing progress meeting a first preset condition.

In this embodiment of the present disclosure, the electronic device can take the first input as a trigger operation to establish the association relationship between the first video and the target component, and quickly and easily establish the association relationship between the first video that is in-completed in playing in the first application and that the user needs to continue to play later and the target component, so that when the user needs to view the first video later, the first video may be directly found and played by using the target component, and the user does not need to look through a plurality of applications to find and play the first video. Operation steps are simple and consume less time. In addition, the electronic device can further take the first input as a trigger operation for using the target component to play the second video in the second application with the playing progress meeting the first preset condition, which is convenient for the user to play the second video quickly by using the target component, and prevents the user from finding and playing the second video in the second application, thus saving time.

In an embodiment, that the second video is a video in the second application with a playing progress meeting a first preset condition includes: the second video is a video in the second application with a playing progress less than a first playing progress; or the second video is a video in the second application with a playing progress less than a second playing progress in a preset time period.

In this embodiment of the present disclosure, when the second video in the second application is played by using the target component, the second video may be a video with a playing progress less than the first playing progress in all the historical playing records of the second application, or a video with a playing progress less than the second playing progress in the preset time period of the second application. A corresponding first preset condition is selected based on a user requirement, so that the second video in the second application can be determined more accurately, and the second video can be played quickly by using the target component, to meet the user requirement.

In an embodiment, the video management apparatus 800 further includes a second receiving module and a first playing module. The second receiving module is configured to receive a second input for the target component from the user. The first playing module is configured to play a third video by using the target component in response to the second input, where the third video is a video in a third application.

In this embodiment of the present disclosure, the electronic device can take the second input performed on the target component as a switching trigger operation to switch a video played by using the target component from the second video to the third video, and quickly and easily switch the second video played by using the target component to the third video. The second video and the third video may be videos of a same application or videos of different applications. Layouts of the second video and the third video may be the same or different, which facilitates switching of different videos with the same layout in the same application in the target component, switching of videos with the same layout in different applications, or switching of videos with different layouts in different applications, and it is convenient for the user to select, according to its own needs, an appropriate switching scheme to switch the second video to the third video. Operation steps are simple, and time can be saved.

In an embodiment, the first receiving module 801 is configured to receive the first input from the user in a case that a video playing interface of the first application is displayed.

The video management apparatus 800 further includes a first display module, a third receiving module, and a second playing module. The first display module is configured to display the target component and a first application identifier in a case that the target operation is to establish the association relationship between the first video in the first application and the target component, where the first application identifier is used to indicate the first application. The third receiving module is configured to receive a third input for the target component and the first application identifier from the user. The second playing module is configured to play the first video by using the target component in response to the third input.

In this embodiment of the present disclosure, the electronic device can take the third input performed on the target component and the first application identifier as a playing trigger operation for using the target component to play the first video in the first application, which is convenient for the user to quickly locate, in the target component, the first video in the first application, and prevents the user from finding, in the target component, the first video corresponding to the first application. This is easy to operate and can save time.

In an embodiment, the execution module 802 is further configured to cancel performing the target operation in a case that a second preset condition is met. The second preset condition includes any one of the following: a playing progress of playing a first target video by using the target component is greater than a third playing progress; and a deletion operation performed by the user on the first target video is received, where the first target video is the first video or the second video.

In this embodiment of the present disclosure, in a case that the playing progress of playing the first target video by using the target component is greater than the third playing progress, it indicates that the first target video is completed in playing, and the electronic device may automatically cancel the association relationship between the first target video and the target component, so that the user does not need to manually cancel the association relationship between the first target video and the target component after the first target video is completed in playing. In addition, the electronic device can take the deletion operation performed on the first target video in the target component as a trigger operation to cancel the association relationship between the first target video and the target component, and can manually cancel the association relationship between the first target video and the target component in a case that the playing progress of the first target video is less than the third playing progress, and the user does not expect to continue to view the first target video later, which is convenient for the user to manage the first target video in the target component, and the first target video that is completed in playing may not affect the user to find other videos in the target component. Operation steps are simple, and time can be saved.

In an embodiment, the video management apparatus 800 further includes a fourth receiving module, a third playing module, and a fourth playing module. The fourth receiving module is configured to receive a fourth input for the target component and a target application in a case that a second target video is played by using the target component. The third playing module is configured to: in a case that the second target video is a video in the target application, in response to the fourth input, play the second target video when the target application is started. The fourth playing module is configured to: in a case that the second target video is a video in a fourth application, in response to the fourth input, play a fourth video when the target application is started, where the fourth video is associated with the second target video. The second target video is the first video, and the target application is the first application; or the second target video is the second video, and the target application is the second application.

In this embodiment of the present disclosure, in a case that the target application has the playing copyright of the second target video, the fourth input may be used to determine the second target video as the to-be-played video of the target application, and the predetermined to-be-played video may be automatically played by using the target application when the target application is started, which prevents the user from still finding and playing the second target video in the target application or the target component. Operation steps are simple and quick, and time can be saved. In a case that the target application does not have the playing copyright of the second target video, the fourth video associated with the second target video may be determined in the target application through the fourth input, and the fourth video may be automatically played by using the target application when the target application is started, to recommend videos to the user according to user preferences.

In an embodiment, the video management apparatus 800 further includes a fifth playing module and a second display module. The fifth playing module is configured to play a third target video by using the target component. The second display module is configured to display video information of the third target video on a video playing interface, where the third target video is the first video or the second video. The video information includes at least one of video playing mode information, a video theme, a video publisher, video duration, a video playing progress, and a video source application.

In this embodiment of the present disclosure, in a case that the third target video is played by using the target component, at least one of video playing mode information, a theme, a publisher, duration, a playing progress, and a source application of the third target video is displayed on the video playing interface of the third target video, which is convenient for the user to quickly and intuitively learn of video information of the third target video, and avoids the user from viewing more video information about the third target video through other operations, thus saving time.

In an embodiment, the second display module is configured to display association information on a video page of the third video with a second display parameter based on a first display parameter of the video page of the third target video. The first display parameter includes at least one of a video page layout of the third target video and a video page color of the third target video. The second display parameter includes at least one of a display location of the video information and a color attribute of the video information.

In this embodiment of the present disclosure, a display location and a display color of the video information on the video page of the third target video may be adaptively adjusted based on the video page layout and the video page color of the third target video, to avoid affecting the video page of the third target video when the video information of the third target video is displayed on the video page of the third target video, so that the video page of the third target video and the video information of the third target video can be displayed normally with good display effect.

The video management apparatus in this embodiment of this application may be an electronic device, or may be a component such as an integrated circuit or a chip in the electronic device. The electronic device may be a terminal, or another device other than the terminal. For example, the electronic device may be a mobile phone, a tablet computer, a notebook computer, a palmtop computer, an in-vehicle electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like. In some embodiments, the electronic device may be a server, a Network Attached Storage (NAS), a Personal Computer (PC), a television (TV), a teller machine, a self-service machine, or the like. This is not specifically limited in this embodiment of this application.

The video management apparatus in this embodiment of this application may be an apparatus with an operating system. The operating system may be an Android operating system, may be an iOS operating system, or may be another possible operating system. This is not specifically limited in this embodiment of this application.

The video management apparatus provided in this embodiment of this application can implement processes implemented in the method embodiments from FIG. 1 to FIG. 7. To avoid repetition, details are not described herein again.

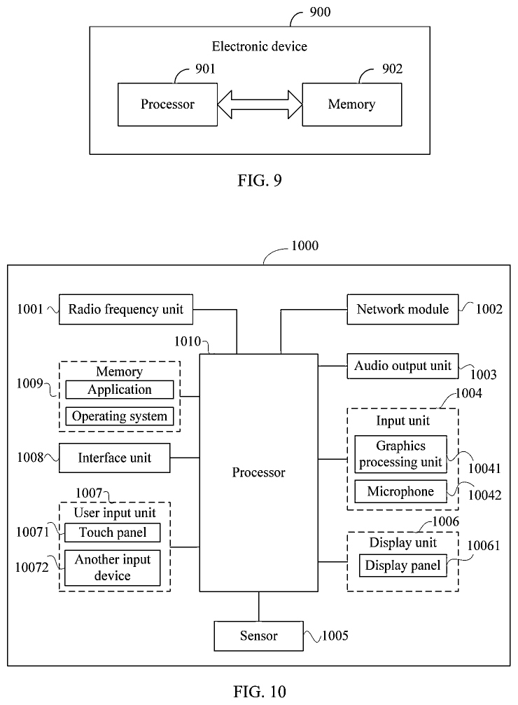

For example, as shown in FIG. 9, an embodiment of this application further provides an electronic device 900, including a processor 901 and a memory 902. The memory 902 stores a program or an instruction that can be run on the processor 901, and the program or the instruction is executed by the processor 901 to implement the steps of the foregoing video management method embodiment, and a same technical effect can be achieved. To avoid repetition, details are not described herein again.

It should be noted that the electronic device in this embodiment of this application includes the foregoing mobile electronic device and the foregoing non-mobile electronic device.

FIG. 10 is a schematic diagram of a hardware structure of an electronic device according to an embodiment of this application.

An electronic device 1000 includes but is not limited to components such as a radio frequency unit 1001, a network module 1002, an audio output unit 100, an input unit 1004, a sensor 1005, a display unit 1006, a user input unit 1007, an interface unit 1008, a memory 1009, and a processor 1010.

A person skilled in the art can understand that the electronic device 1000 may further include the power supply (for example, a battery) that supplies power to each component. The power supply may be logically connected to the processor 1010 by using a power supply management system, so as to manage functions such as charging, discharging, and power consumption by using the power supply management system. The structure of the electronic device shown in FIG. 10 does not constitute a limitation on the electronic device, and the electronic device may include more or fewer components than those shown in the figure, or combine some components, or have different component arrangements. Details are not described herein again.

The user input unit 1007 is configured to receive a first input from a user. The processor 1010 is configured to perform a target operation in response to the first input. The target operation includes any one of the following: establishing an association relationship between a first video in a first application and a target component, where the association relationship is used to indicate that the first video is able to be played by using the target component; and playing a second video in a second application by using the target component, where the second video is a video in the second application with a playing progress meeting a first preset condition.

For example, that the second video is a video in the second application with a playing progress meeting a first preset condition includes: the second video is a video in the second application with a playing progress less than a first playing progress; or the second video is a video in the second application with a playing progress less than a second playing progress in a preset time period.

For example, the user input unit 1007 is further configured to receive a second input for the target component from the user. The display unit 1006 is configured to play a third video by using the target component in response to the second input, where the third video is a video in a third application.

For example, the user input unit 1007 is configured to receive the first input from the user in a case that a video playing interface of the first application is displayed. The display unit 1006 is further configured to display the target component and a first application identifier in a case that the target operation is to establish the association relationship between the first video in the first application and the target component, where the first application identifier is used to indicate the first application. The user input unit 1007 is further configured to receive a third input for the target component and the first application identifier from the user. The display unit 1006 is further configured to play the first video by using the target component in response to the third input.

For example, the processor 1010 is further configured to cancel performing the target operation in a case that a second preset condition is met. The second preset condition includes any one of the following: a playing progress of playing a first target video by using the target component is greater than a third playing progress; and a deletion operation performed by the user on the first target video is received, where the first target video is the first video or the second video.

For example, the user input unit 1007 is further configured to receive a fourth input for the target component and a target application in a case that a second target video is played by using the target component. The display unit 1006 is further configured to: in a case that the second target video is a video in the target application, in response to the fourth input, play the second target video when the target application is started; and in a case that the second target video is a video in a fourth application, in response to the fourth input, play a fourth video when the target application is started, where the fourth video is associated with the second target video. The second target video is the first video, and the target application is the first application; or the second target video is the second video, and the target application is the second application.

For example, the display unit 1006 is further configured to: play a third target video by using the target component, and display video information of the third target video on a video playing interface, where the third target video is the first video or the second video. The video information includes at least one of video playing mode information, a video theme, a video publisher, video duration, a video playing progress, and a video source application.

For example, the display unit 1006 is configured to display association information on a video page of the third video with a second display parameter based on a first display parameter of the video page of the third target video. The first display parameter includes at least one of a video page layout of the third target video and a video page color of the third target video. The second display parameter includes at least one of a display location of the video information and a color attribute of the video information.

In this embodiment of the present disclosure, the electronic device can take the first input as a trigger operation to establish the association relationship between the first video and the target component, and quickly and easily establish the association relationship between the first video that is in-completed in playing in the first application and that the user needs to continue to play later and the target component, so that when the user needs to view the first video later, the first video may be directly found and played by using the target component, and the user does not need to look through a plurality of applications to find and play the first video. Operation steps are simple and consume less time. In addition, the electronic device can further take the first input as a trigger operation for using the target component to play the second video in the second application with the playing progress meeting the first preset condition, which is convenient for the user to play the second video quickly by using the target component, and prevents the user from finding and playing the second video in the second application, thus saving time.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

The memory 1009 may be configured to store a software program and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any memory of another proper type.

The processor 1010 may include one or more processing units. For example, an application processor and a modem processor are integrated into the processor 1010. The application processor mainly processes an operating system, a user interface, an application, or the like. The modem processor mainly processes a wireless communication signal, for example, a baseband processor. It may be understood that, in some embodiments, the modem processor may not be integrated into the processor 1010.

An embodiment of this application further provides a readable storage medium. The readable storage medium stores a program or an instruction, and when the program or the instruction is executed by a processor, the processes of the foregoing video management method embodiment are implemented, and a same technical effect can be achieved. To avoid repetition, details are not described herein again.

The processor is the processor in the electronic device in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing video management method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium, and the program product is executed by at least one processor to implement the processes of the foregoing video management method embodiment, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (such as a ROM/RAM, a hard disk, or a compact disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A video management method, comprising:
receiving a first input from a user; and
performing a target operation in response to the first input, wherein
the target operation comprises any one of the following:
establishing an association relationship between a first video in a first application and a target component, wherein the association relationship is used to indicate that the first video is able to be played by using the target component; or
playing a second video in a second application by using the target component, wherein the second video is a video in the second application with a playing progress meeting a first preset condition.

2. The video management method according to claim 1, wherein the second video is the video in the second application with the playing progress meeting the first preset condition comprises:
the second video is a video in the second application with the playing progress less than a first playing progress; or
the second video is a video in the second application with the playing progress less than a second playing progress in a preset time period.

3. The video management method according to claim 1, wherein after the performing the target operation in response to the first input, the method further comprises:
receiving a second input for the target component from the user; and
playing a third video by using the target component in response to the second input, wherein the third video is a video in a third application.

4. The video management method according to claim 1, wherein the receiving the first input from the user, and performing the target operation in response to the first input comprises:
receiving the first input from the user when a video playing interface of the first application is displayed; and
performing the target operation in response to the first input,
wherein after the performing the target operation, the method further comprises:
displaying the target component and a first application identifier when the target operation is to establish the association relationship between the first video in the first application and the target component, wherein the first application identifier is used to indicate the first application;
receiving a third input for the target component and the first application identifier from the user; and
playing the first video by using the target component in response to the third input.

5. The video management method according to claim 1, wherein after the performing the target operation in response to the first input, the method further comprises:
canceling performing the target operation when a second preset condition is met,
wherein the second preset condition comprises any one of the following:
a playing progress of playing a first target video by using the target component is greater than a third playing progress; or
a deletion operation performed by the user on the first target video is received,
wherein the first target video is the first video or the second video.

6. The video management method according to claim 1, wherein after the performing the target operation in response to the first input, the method further comprises:
receiving a fourth input for the target component and a target application when a second target video is played by using the target component;
when the second target video is a video in the target application, in response to the fourth input, playing the second target video when the target application is started; and
when the second target video is a video in a fourth application, in response to the fourth input, playing a fourth video when the target application is started, wherein the fourth video is associated with the second target video, wherein
the second target video is the first video, and the target application is the first application; or
the second target video is the second video, and the target application is the second application.

7. The video management method according to claim 1, wherein after the performing the target operation, the method further comprises:
playing a third target video by using the target component, and displaying video information of the third target video on a video playing interface, wherein the third target video is the first video or the second video; and
the video information comprises at least one of video playing mode information, a video theme, a video publisher, video duration, a video playing progress, or a video source application.

8. The video management method according to claim 7, wherein the displaying video information of the third target video on the video playing interface comprises:
displaying the video information on a video page of the third target video with a second display parameter based on a first display parameter of the video page of the third target video, wherein
the first display parameter comprises at least one of a video page layout of the third target video or a video page color of the third target video; and
the second display parameter comprises at least one of a display location of the video information or a color attribute of the video information.

9. An electronic device, comprising a processor and a memory storing instructions, wherein the instructions, when executed by the processor, cause the processor to perform operations comprising:
receiving a first input from a user; and
performing a target operation in response to the first input, wherein
the target operation comprises any one of the following:
establishing an association relationship between a first video in a first application and a target component, wherein the association relationship is used to indicate that the first video is able to be played by using the target component; or
playing a second video in a second application by using the target component, wherein the second video is a video in the second application with a playing progress meeting a first preset condition.

10. The electronic device according to claim 9, wherein the second video is the video in the second application with the playing progress meeting the first preset condition comprises:
the second video is a video in the second application with the playing progress less than a first playing progress; or
the second video is a video in the second application with the playing progress less than a second playing progress in a preset time period.

11. The electronic device according to claim 9, wherein after the performing the target operation in response to the first input, the instructions, when executed by the processor, cause the processor to further perform operations comprising:
receiving a second input for the target component from the user; and
playing a third video by using the target component in response to the second input, wherein the third video is a video in a third application.

12. The electronic device according to claim 9, wherein the receiving the first input from the user, and performing the target operation in response to the first input comprises:
receiving the first input from the user when a video playing interface of the first application is displayed; and
performing the target operation in response to the first input,
wherein after the performing the target operation, the instructions, when executed by the processor, cause the processor to further perform operations comprising:
displaying the target component and a first application identifier when the target operation is to establish the association relationship between the first video in the first application and the target component, wherein the first application identifier is used to indicate the first application;
receiving a third input for the target component and the first application identifier from the user; and
playing the first video by using the target component in response to the third input.

13. The electronic device according to claim 9, wherein after the performing the target operation in response to the first input, the instructions, when executed by the processor, cause the processor to further perform operations comprising:
canceling performing the target operation when a second preset condition is met,
wherein the second preset condition comprises any one of the following:
a playing progress of playing a first target video by using the target component is greater than a third playing progress; or
a deletion operation performed by the user on the first target video is received,
wherein the first target video is the first video or the second video.

14. The electronic device according to claim 9, wherein after the performing the target operation in response to the first input, the instructions, when executed by the processor, cause the processor to further perform operations comprising:
receiving a fourth input for the target component and a target application when a second target video is played by using the target component;
when the second target video is a video in the target application, in response to the fourth input, playing the second target video when the target application is started; and
when the second target video is a video in a fourth application, in response to the fourth input, playing a fourth video when the target application is started, wherein the fourth video is associated with the second target video, wherein
the second target video is the first video, and the target application is the first application; or
the second target video is the second video, and the target application is the second application.

15. The electronic device according to claim 9, wherein after the performing the target operation, the instructions, when executed by the processor, cause the processor to further perform operations comprising:
playing a third target video by using the target component, and displaying video information of the third target video on a video playing interface, wherein the third target video is the first video or the second video; and
the video information comprises at least one of video playing mode information, a video theme, a video publisher, video duration, a video playing progress, or a video source application.

16. The electronic device according to claim 15, wherein the displaying video information of the third target video on the video playing interface comprises:
displaying the video information on a video page of the third target video with a second display parameter based on a first display parameter of the video page of the third target video, wherein
the first display parameter comprises at least one of a video page layout of the third target video or a video page color of the third target video; and
the second display parameter comprises at least one of a display location of the video information or a color attribute of the video information.

17. A non-transitory computer readable storage medium storing instructions, that, when executed by a processor of an electronic device, cause the processor to perform operations comprising:
receiving a first input from a user; and
performing a target operation in response to the first input, wherein
the target operation comprises any one of the following:
establishing an association relationship between a first video in a first application and a target component, wherein the association relationship is used to indicate that the first video is able to be played by using the target component; or
playing a second video in a second application by using the target component, wherein the second video is a video in the second application with a playing progress meeting a first preset condition.

18. The non-transitory computer readable storage medium according to claim 17, wherein the second video is the video in the second application with the playing progress meeting the first preset condition comprises:
the second video is a video in the second application with the playing progress less than a first playing progress; or
the second video is a video in the second application with the playing progress less than a second playing progress in a preset time period.

19. The non-transitory computer readable storage medium according to claim 17, wherein after the performing the target operation in response to the first input, the instructions, when executed by the processor, cause the processor to further perform operations comprising:
receiving a second input for the target component from the user; and
playing a third video by using the target component in response to the second input, wherein the third video is a video in a third application.

20. The non-transitory computer readable storage medium according to claim 17, wherein the receiving the first input from the user, and performing the target operation in response to the first input comprises:
receiving the first input from the user when a video playing interface of the first application is displayed; and
performing the target operation in response to the first input,
wherein after the performing the target operation, the instructions, when executed by the processor, cause the processor to further perform operations comprising:
displaying the target component and a first application identifier when the target operation is to establish the association relationship between the first video in the first application and the target component, wherein the first application identifier is used to indicate the first application;
receiving a third input for the target component and the first application identifier from the user; and
playing the first video by using the target component in response to the third input.
